(19) United States
(12) Patent Application Publication
(10) Pub. No.: US 2006/0274020 A1
(43) Pub. Date: Dec. 7, 2006

(54) Apparatus and methods for controlled transition between charge sharing and video output in a liquid crystal display

(76) Inventors: Siwang Sung, Gyeonggi-do (KR); Junhong Park, Seoul (KR)

Correspondence Address: MYERS BIGEL SIBLEY & SAJOVEC, PO BOX 37428, RALEIGH, NC, 27627, US

(21) Appl. No.: 11/266,426

(22) Filed: Nov. 3, 2005

(30) Foreign Application Priority Data
Jun. 7, 2005 (KR) 2005-48519

(51) Int. Cl. G09G 3/36

(52) U.S. Cl. 345/100

(57) ABSTRACT

An output circuit for driving a liquid crystal display (LCD) data line includes a selection circuit having a first input, a second input coupled to a charge sharing line, and an output coupled to the LCD data line. The selection circuit is configured to selectively couple the first and second inputs to the LCD data line responsive to a charge sharing control signal. The output circuit further includes a data line voltage source circuit coupled to the first input of the selection circuit and configured to provide data line voltage thereto responsive to the charge sharing control signal.

### CROSS REFERENCE TO RELATED APPLICATION

This application claims priority under 35 USC §119 to Korean Patent Application No. 10-2005-0048519 filed on Jun. 7, 2005, the disclosure of which is herein incorporated by reference in its entirety.

### BACKGROUND OF THE INVENTION

The present invention relates to liquid crystal display (LCD) devices and methods of operation thereof and, more particularly, to LCD source drivers and methods of operation thereof.

Referring to FIG. 1, a typical LCD apparatus includes a source driver 10 and a gate driver 12, which respectively drive data lines DL1, DL2, . . . , DLn and gate lines GL1, GL2, . . . , GLm of an LCD panel including a plurality of thin film transistors (TFT) T1 that access respective liquid crystal elements C1. The gate driver 12 typically sequentially drives the gate lines GL1, GL2, . . . , GLm. When a given gate line is driven, all transistors connected thereto typically turn on. The source driver 10 typically drives the data lines DL1, DL2, . . . , DLn with display data. The source driver typically includes a shift register, a digital-to-analog converter (DAC) and an output circuit that receives analog data signals from the DAC and responsively drives the data lines.

Commonly, an LCD apparatus alternates the polarity of voltage applied to the liquid crystal elements C1. Common inversion techniques include frame inversion, line inversion, column inversion and dot inversion. Charge sharing can lower power consumption by transferring charge between the data lines. Charge sharing may be particularly advantageous when used with dot inversion.

FIG. 2 illustrates a conventional source driver. The source driver includes a DAC 250 and an output circuit 200. The DAC 250 includes a plurality of decoders 251-1, 251-2, . . . 251-n. Each decoder 251-1, 251-2, . . . 251-n receives a 6-bit digital data input and responsively produces an analog output from among 64 gray scale voltages V1, V2, . . . , V64. The output circuit 200 includes a plurality of buffer circuits, here shown as unity-gain voltage follower amplifier circuits 211-1, 211-2, . . . , 211-n, along with first switches (SW1) 221-1, 221-2, . . . , 221-n, second switches (SW2) (231-1, 231-2, . . . , 231-n), and a charge sharing line SL.

The voltage follower amplifier circuits 211-1, 211-2, . . . , 211-n receive voltages from the decoders 251-1, 251-2, . . . 251-n and responsively produce output voltages VO1, V02, . . . , VOn. The first switches 221-1, 221-2, . . . , 221-n, second switches (231-1, 231-2, . . . , 231-n), and charge sharing line SL are used to share charge between the data lines DL1, DL2, . . . , DLn when a clock signal TP is asserted, and apply the output voltages VO1, V02, . . . , VOn to the data lines DL1, DL2, . . . , DLn when a complement nTP of the clock signal TP is asserted. Respective capacitances Ctot include capacitances between the respective data lines DL1, DL2, . . . , DLn and a common electrode Vcom, which may include TFT gate-to-source capacitance, gate-to-drain capacitance and drain-to-source capacitance, along with capacitance between the TFT drain and the common electrode Vcom.

FIG. 3 is a timing diagram of the data line DL1 when the clock signal TP is asserted for a relatively short period of time with respect to a time interval (delay) tr-t0 between a step change in the input voltage VI1 the voltage follower amplifier circuit 211-1 to a voltage Va and change of the output voltage V to the voltage Va. When the clock signal TP transitions from “low” to “high” at time t0, the first switch 221-1 is turned on. The data line DL1 rises to the voltage VSL of the shared line SL. In response to a change of the input voltage VI1 to Va, the voltage follower amplifier circuit 211-1 gradually drives the output voltage VO1 towards Va. When the clock signal TP changes from “high” to “low” at time t1, the first switch 221-1 turns off and the second switch 231-1 turns on, such that the voltage follower amplifier circuit 211-1 drives the data line DL1. Consequently, the voltage on the data line DL1 follows the output voltage VO1 of the voltage follower amplifier circuit 211-1 between time t1 and time tr.

FIG. 4 is a timing diagram of the data line DL1 when the clock signal TP is asserted for a relatively long period of time with respect to the time interval tr-t0. When the clock signal TP changes from “high” to “low” at time t2, the voltage of the data line DL1 may change relatively abruptly to the input voltage level Va. This may cause a disruption in the voltage level of the common electrode Vcom, which may disrupt the display.

### SUMMARY OF THE INVENTION

In some embodiments of the present invention, an output circuit for driving a liquid crystal display (LCD) data line includes a selection circuit having a first input, a second input coupled to a charge sharing line, and an output coupled to the LCD data line. The selection circuit is configured to selectively couple the first and second inputs to the LCD data line responsive to a charge sharing control signal. The output circuit further includes a data line voltage source circuit coupled to the first input of the selection circuit and configured to provide a data line voltage thereto responsive to the charge sharing control signal.

In some embodiments of the present invention, the data line voltage source circuit may be configured to selectively couple first and second voltage sources to the first input of the selection circuit responsive to the charge sharing control signal. For example, the selection circuit may comprise a first selection circuit, and the data line voltage source circuit may include a buffer circuit, e.g., a voltage follower or other amplifier circuit, having an output coupled to the first input of the first selection circuit and a second selection circuit having a first input coupled to the first voltage source, a second input coupled to the second voltage source, and an output coupled to an input of the buffer circuit. The second selection circuit may be configured to selectively couple the first and second voltage sources to the buffer circuit input responsive to the charge sharing control signal.

In some embodiments, the first voltage source may comprise a video voltage source, and the second voltage source may comprise the charge sharing line. The first selection circuit may be configured to couple the buffer circuit output to the LCD data line responsive to a first state of the charge sharing control signal and to couple the charge sharing line to the LCD data line responsive to a second state of the charge sharing control signal. The second selection circuit may be configured to couple the video voltage source to buffer circuit input responsive to the first state of the charge sharing control signal and to couple the charge sharing line to the buffer circuit input responsive to the second state of the charge sharing control signal. The video voltage source may comprise, for example, a digital-to-analog converter (DAC).

In some embodiments of the present invention, the first voltage source may comprise a video voltage source, for example, a DAC, and the second voltage source may comprise a reference voltage source, for example, a fixed voltage source. The first selection circuit may be configured to couple the buffer circuit output to the LCD data line responsive to a first state of the charge sharing control signal and to couple the charge sharing line to the LCD data line responsive to a second state of the charge sharing control signal. The second selection circuit may be configured to couple the video voltage source to the buffer circuit input responsive to the first state of the charge sharing control signal and to couple the reference voltage source to the buffer circuit input responsive to the second state of the charge sharing control signal.

In additional embodiments of the present invention, an LCD source driver circuit includes a video voltage source and a buffer circuit. A first selection circuit has a first input coupled to an output of the buffer circuit, a second input coupled to a charge sharing line, and an output configured to be coupled to an LCD data line. The first selection circuit is further configured to selectively couple the buffer circuit and the charge sharing line to the LCD data line responsive to a charge sharing control signal. A second selection circuit has a first input coupled to the video voltage source, a second input coupled to an alternative voltage source, and an output coupled to an input of the buffer circuit. The second selection circuit is further configured to selectively couple the video voltage source and the alternative voltage source to the buffer circuit input responsive to the charge sharing control signal. The alternative voltage source may comprise, for example, the charge sharing line or a reference voltage source. The video voltage source may comprise a digital-to-analog converter (DAC).

In some method embodiments of the present invention, methods are provided for operating a LCD source driver that includes a selection circuit having an output coupled to a LCD data line, a first input configured to be coupled to a voltage source, and a second input coupled to a charge sharing line. The first and second inputs of the selection circuit are selectively coupled to the LCD data line responsive to a charge sharing control signal. A voltage at the first input of the selection circuit is controlled responsive to the charge sharing control signal. Controlling voltage at the first input of the selection circuit may comprise selectively coupling a video voltage source and an alternative voltage source to the first input of the selection circuit responsive to the charge sharing control signal. The alternative voltage source may comprise, for example, the charge sharing line or a reference voltage source. The video voltage source and the alternative voltage source may be selectively applied to an input of a buffer circuit having an output coupled to the first input of the selection circuit.

### BRIEF DESCRIPTION OF THE DRAWINGS

FIG. 1 is a schematic diagram illustrating a conventional LCD apparatus.

FIG. 2 is a schematic diagram illustrating a conventional source driver circuit for an LCD apparatus.

FIGS. 3 and 4 are timing diagrams illustrating exemplary operations of the source driver circuit of FIG. 2.

FIG. 5 is a schematic diagram of a source driver circuit according to some embodiments of the present invention.

FIGS. 6 and 7 are timing diagrams illustrating exemplary operations of the source driver circuit of FIG. 5 according to further embodiments of the present invention.

FIG. 8 is a schematic diagram of a source driver circuit according to additional embodiments of the present invention.

FIG. 9 is a timing diagram illustrating exemplary operations of the source driver circuit of FIG. 8 according to further embodiments of the present invention.

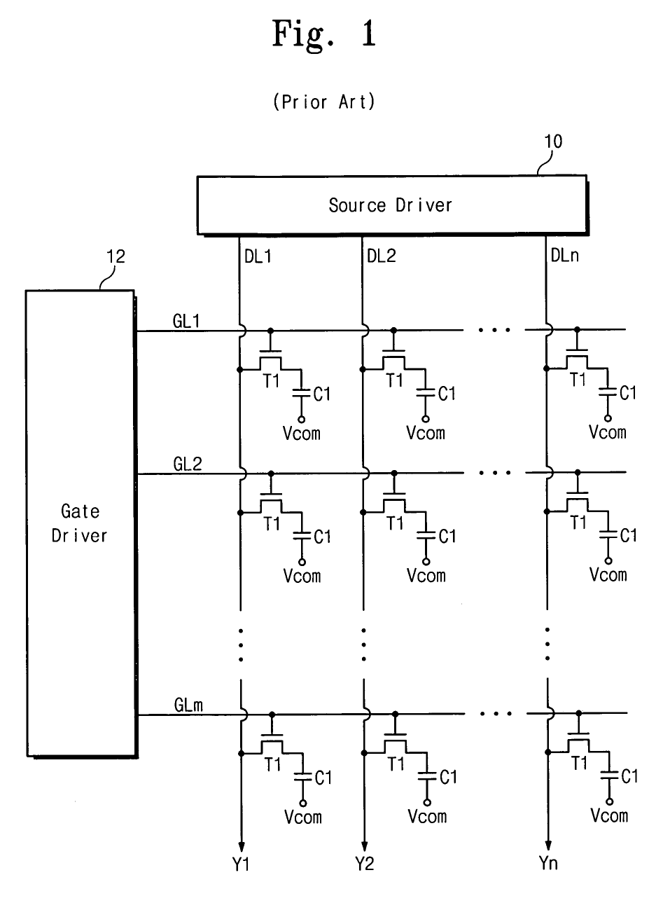

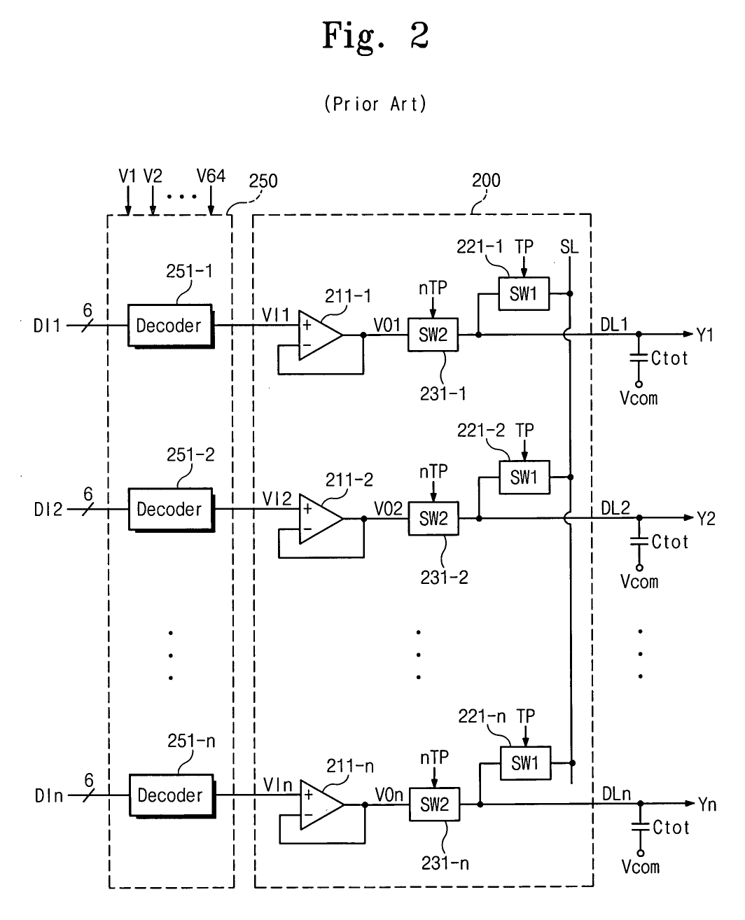

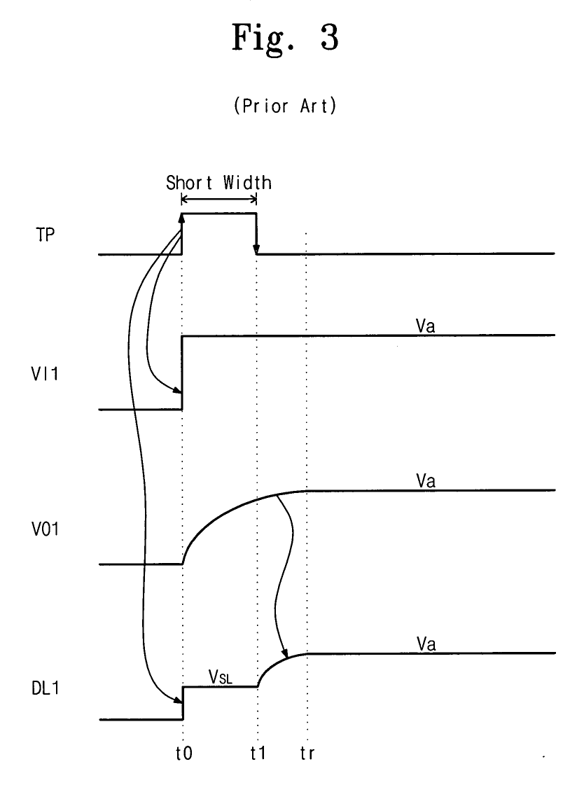

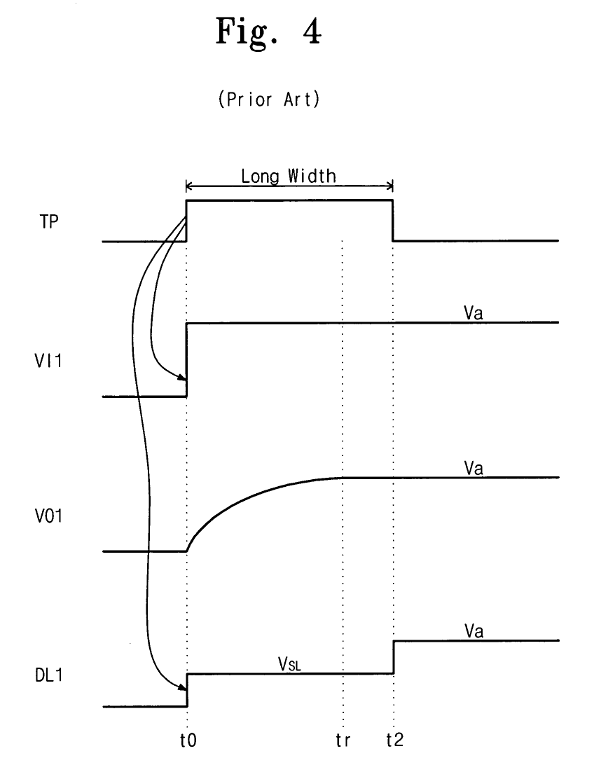

### DETAILED DESCRIPTION OF EXEMPLARY EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, third etc. may be used herein to describe various elements, components and/or sections, these elements, components and/or sections should not be limited by these terms. These terms are only used to distinguish one element, component, or section from another element, region or section. Thus, a first element, component or section discussed below could be termed a second element, component or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

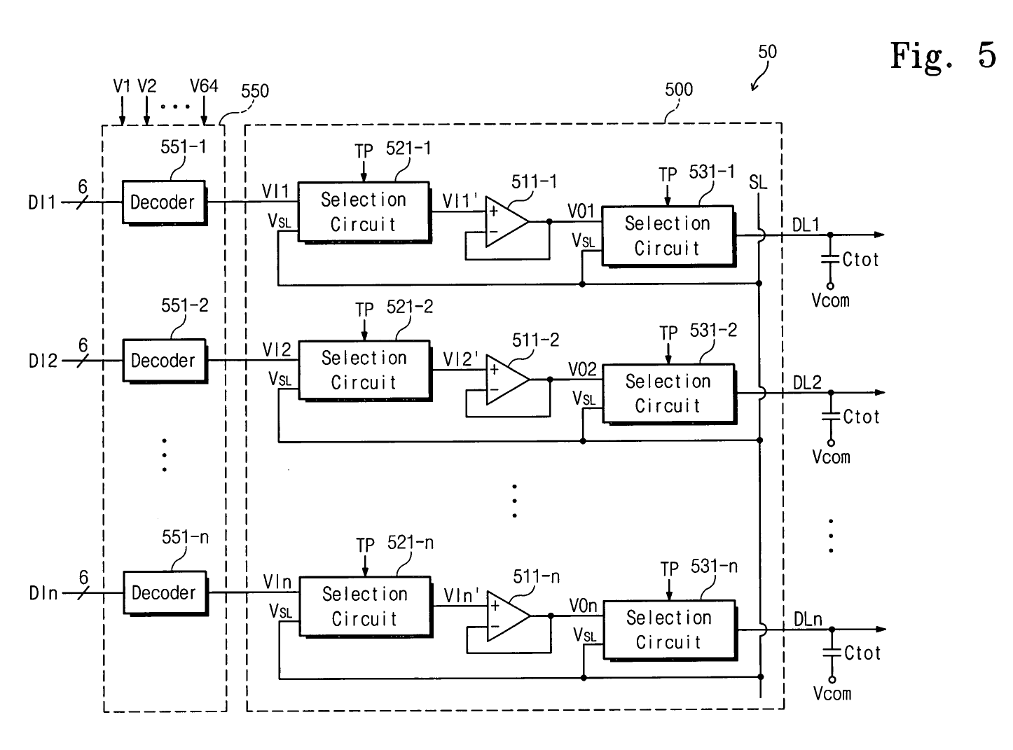

FIG. 5 illustrates a source driver circuit 50 according to some embodiments of the present invention. The source driver circuit 50 includes a digital-to-analog converter (DAC) 550 and an output circuit 500. The DAC 550 includes a plurality of decoders 551-1, 551-2, . . . , 551-n that are configured to generate analog video voltages VI1, VI2, . . . , VIn responsive to digital inputs DI1, DI2, . . . , DIn. The video voltages VI1, . . . , VIn are selected from among a plurality of gray scale voltages V1, V2, . . . , V64 based on the digital inputs DI1, DI2, . . . , DIn.

The output circuit 500 includes selection circuits 521-1, 521-2, . . . , 521-n having first inputs that receive the respective video voltages VI1, . . . , VIn and second inputs that are each coupled to a charge sharing line SL, which may be included in the output circuit 500 or external thereto. Responsive to a clock signal TP, the selection circuits 521-1, 521-2, . . . , 521-n selectively apply the respective video voltages VI1, VI2, . . . , VIn or a voltage VSL of the charge sharing line SL as input signals VI1′, VI2′, . . . , VIn′ to inputs of respective buffer circuits, here shown as unity-gain voltage follower amplifier circuits 511-1, 511-2, . . . , 511-n. The voltage follower amplifier circuits 511-1, 511-2, . . . , 511-n responsively generate output voltages VO1, VO2, . . . , VOn. It will be appreciated that, in some embodiments of the present invention, buffer circuits may take forms other than unity-gain voltage followers, such as non-unity gain amplifier circuits and/or filter circuits.

The output circuit 500 further includes selection circuits 531-1, 531-2, . . . , 531-n having first inputs that receive the respective output voltages VO1, VO2, . . . , VOn and second inputs that are also coupled to the charge sharing line SL. Responsive to the clock signal TP, the selection circuits 531-1, 531-2, . . . , 531-n selectively apply the output voltages VO1, VO2, . . . , VOn or the charge sharing line voltage VSL to LCD panel data lines DL1, DL2, . . . , DLn.

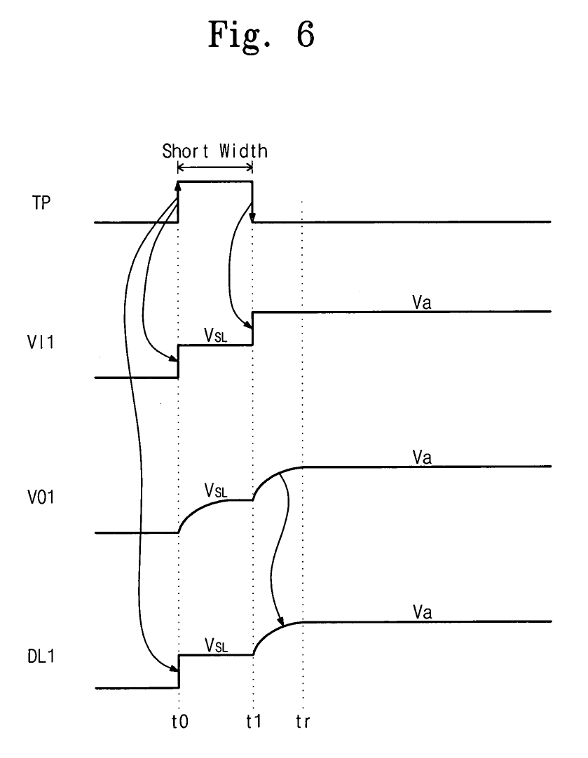

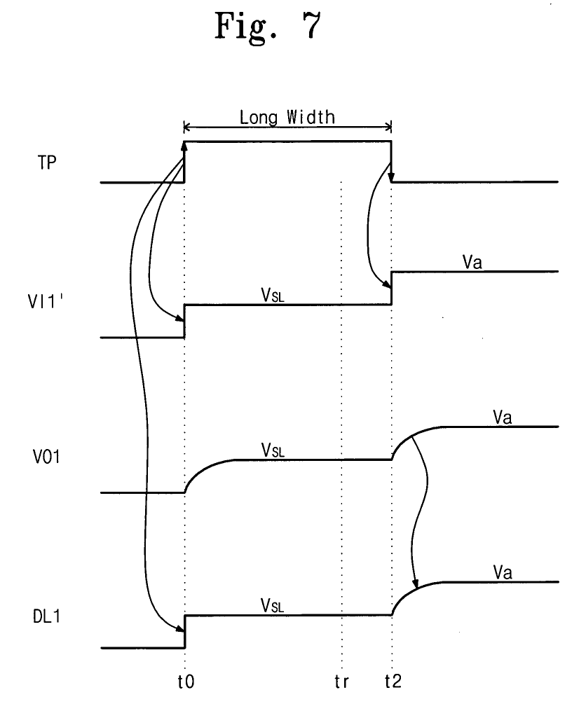

FIGS. 6 and 7 illustrate exemplary operations of one path of the source driver circuit 50 of FIG. 5 for relatively short and long pulse durations, respectively, of the clock signal TP. Referring to FIG. 6, at or near a time t0, the video voltage VI1 transitions to a voltage Va and the clock signal TP is asserted “high.” This causes the selection circuit 521-1 to apply the charge sharing line voltage VSL to the voltage follower amplifier circuit 511-1. In response, the output voltage VO1 gradually increases to the charge sharing line voltage VSL. The second selection circuit 531-1 also applies the charge sharing line voltage VSL to the data line DL1 in response to the “high” level of the clock signal TP.

At time t1 occurring before a time tr, which substantially corresponds to a delay of the voltage follower amplifier circuit 511-1 in response to a step change in the input voltage VI1, the clock signal TP is sent “low,” which causes the selection circuit 521-1 to apply the video voltage VI1 to the voltage follower amplifier circuit 511-1. In response, the output voltage VO1 gradually increases from the charge sharing voltage VSL to the voltage Va at the time tr. The selection circuit 531-1 applies the output voltage VO1 to the data line DL1, which causes the voltage on the data line DL1 to gradually rise from the charge sharing line voltage VSL to the voltage Va.

In FIG. 7, the “high” level of the clock signal TP is maintained beyond the time tr. In this case, the voltage on the data line DL1 transitions in a manner similar to that described above with reference to FIG. 6, i.e., the voltage on the data line DL1 first transitions to the charge sharing line voltage VSL during the “high” period of the clock signal TP, and then gradually increases to the voltage Va responsive to the transition of the clock signal TP to a logic “low” level. Thus, an abrupt transition of the voltage on the data line DL1 may be avoided, in spite of the duration of the pulse of the clock signal TP.

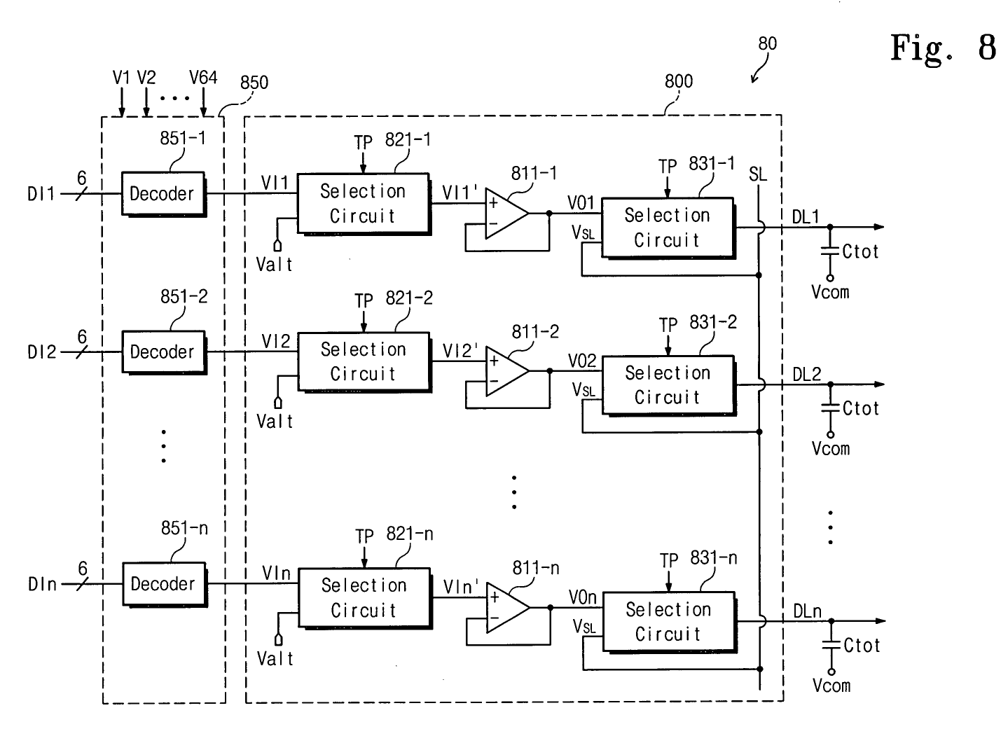

FIG. 8 illustrates a source driver circuit 80 according to further embodiments of the present invention. The source driver circuit 80 includes a DAC 850 and an output circuit 800. The DAC 850 includes a plurality of decoders 851-1, 851-2, . . . , 851-n that are configured to generate analog video voltages VI1, VI2, . . . , VIn responsive to digital inputs DI1, DL2, . . . , DIn. The video voltages VI1, VI2, . . . , VIn are selected from among a plurality of gray scale voltages V1, V2, . . . , V64 based on the digital inputs DI1, DI2, . . . , DIn.

The output circuit 800 includes selection circuits 821-1, 821-2, . . . , 821-n having first inputs that receive the respective video voltages VI1, VI2, . . . , VIn and second inputs that receive an alternative voltage Valt. Responsive to a clock signal TP, the selection circuits 821-1, 821-2, . . . , 821-n selectively apply the respective video voltages VI1, V12, . . . , VIn or the alternative voltage Valt as input signals VI1′, VI2′, . . . , VIn′ to inputs of buffer circuits, here shown as unity-gain voltage follower amplifier circuits 811-1, 811-2, . . . , 811-n. The voltage follower amplifier circuits 811-1, 811-2, . . . , 811-n responsively generate output voltages VO1, VO2, . . . , VOn. It will be appreciated that, in some embodiments of the present invention, buffer circuits may take forms other than unity-gain voltage followers, such as non-unity gain amplifier circuits and/or filter circuits.

The output circuit 800 further includes selection circuits 831-1, 831-2, . . . , 831-n having first inputs that receive the respective output voltages VO1, VO2, . . . , VOn and second inputs that are coupled to a charge sharing line SL. Responsive to the clock signal TP, the selection circuits 831-1, 831-2, . . . , 831-n selectively apply the output voltages VO1, V02, . . . , VOn or a charge sharing line voltage VSL to LDC panel data lines DL1, DL2, . . . , DLn.

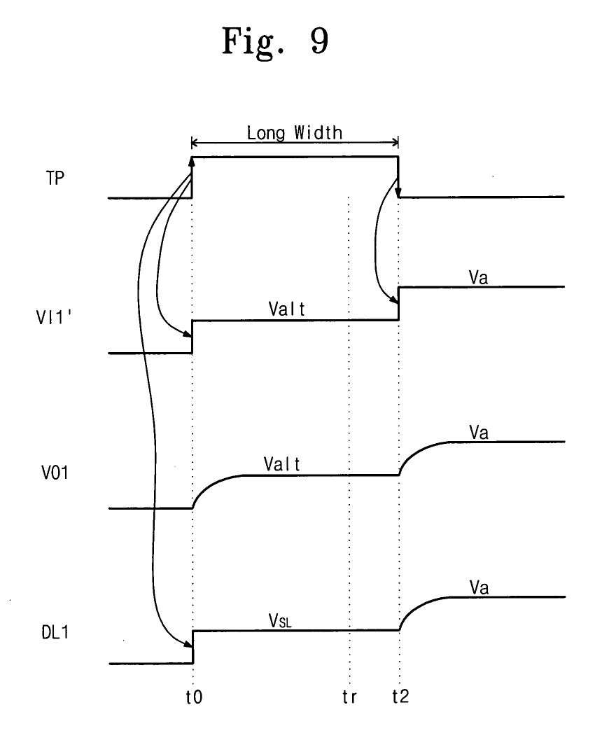

FIG. 9 illustrates exemplary operations of one path of the source driver circuit 80 of FIG. 8. At or near a time tO, the video voltage VI1 transitions to a voltage Va and the clock signal TP is asserted “high.” This causes the selection circuit 821-1 to apply the alternative voltage Vₐₗₜ to the voltage follower amplifier circuit 811-1. In response, the output voltage VO1 gradually increases to the alternative voltage Valt. The second selection circuit 831-1 applies the charge sharing line voltage VSL to the data line DL1 in response to the “high” level of the clock signal TP.

At time t2, the clock signal TP is sent “low.” This causes the selection circuit 821-1 to apply the video voltage VI1 to the voltage follower amplifier circuit 811-1. In response, the output voltage VO1 gradually increases from the alternative voltage Valt to the voltage Va. The second selection circuit 831-1 applies the output voltage VO1 to the data line DL1, which cause the voltage on the data line DL1 to gradually rise to the alternative voltage Valt and then gradually to the voltage Va.

It will be appreciated that an alternative voltage along the lines of the alternative voltage Valt shown in FIG. 8 may be provided in any of a number of different ways. In some embodiments, for example, the alternative voltage Valt may be a fixed or variable reference voltage provided from an external source. In some embodiments, the alternative voltage Valt may be a fixed or variable reference voltage derived from one or more of the gray scale voltages V1, V2, . . . , V64, or some other source. In further embodiments, in contrast to providing the same alternative voltage to selection circuits, such as the selection circuits 821-1, 821-2, . . . , 821-n, different alternative voltages (fixed or variable) may be provided to respective selection. For example, respective alternative voltages could be derived from respective ones of the video voltages VI1, VI2, . . . , VIn using, for example, voltage dividers.

According to various embodiments of the present invention, a data line voltage source circuit, for example, the combination of the DAC 550 and the selection circuits 521-1, 521-2, . . . , 521-n of FIG. 5 or the combination of the DAC 850 and the selection circuits 821-1, 821-2, . . . , 821-n of FIG. 8, provides a data line voltage at an input of a selection circuit that is used to selectively couple an LCD panel data to the data line voltage source and a charge sharing line subject to the charge sharing control signal that controls the selection circuit. Using such an approach, abrupt voltage changes on the data line in response to switching from the charge sharing line to the data line voltage source may be reduced or prevented. This may improve LCD performance.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. An output circuit for driving a liquid crystal display (LCD) data line, the circuit comprising:
a selection circuit having a first input, a second input coupled to a charge sharing line, and an output coupled to the LCD data line, the selection circuit configured to selectively couple the first and second inputs to the LCD data line responsive to a charge sharing control signal; and
a data line voltage source circuit coupled to the first input of the selection circuit and configured to provide a data line voltage at the first input of the selection circuit responsive to the charge sharing control signal.

2. The output circuit of claim 1, wherein the data line voltage source circuit is configured to selectively couple first and second voltage sources to the first input of the selection circuit responsive to the charge sharing control signal.

3. The output circuit of claim 2, wherein the selection circuit comprises a first selection circuit, and wherein the data line voltage source circuit comprises:
a buffer circuit having an output coupled to the first input of the first selection circuit; and
a second selection circuit having a first input coupled to the first voltage source, a second input coupled to the second voltage source, and an output coupled to an input of the buffer circuit, the second selection circuit further configured to selectively couple the first and second voltage sources to the buffer circuit input responsive to the charge sharing control signal.

4. The output circuit of claim 3, wherein the first voltage source comprises a video voltage source, and wherein the second voltage source comprises the charge sharing line.

5. The output circuit of claim 4:
wherein the first selection circuit is configured to couple the buffer circuit output to the LCD data line responsive to a first state of the charge sharing control signal and to couple the charge sharing line to the LCD data line responsive to a second state of the charge sharing control signal; and
wherein the second selection circuit is configured to couple the video voltage source to buffer circuit input responsive to the first state of the charge sharing control signal and to couple the charge sharing line to the buffer circuit input responsive to the second state of the charge sharing control signal.

6. The output circuit of claim 4, wherein the video voltage source comprises a digital-to-analog converter (DAC).

7. The output circuit of claim 3, wherein the first voltage source comprises a video voltage source, and wherein the second voltage source comprises a reference voltage source.

8. The output circuit of claim 7:
wherein the first selection circuit is configured to couple the buffer circuit output to the LCD data line responsive to a first state of the charge sharing control signal and to couple the charge sharing line to the LCD data line responsive to a second state of the charge sharing control signal; and
wherein the second selection circuit is configured to couple the video voltage source to buffer circuit input responsive to the first state of the charge sharing control signal and to couple the reference voltage source to the buffer circuit input responsive to the second state of the charge sharing control signal.

9. The output circuit of claim 7, wherein the video voltage source comprises a digital-to-analog converter (DAC).

10. An LCD source driver circuit, comprising:
a video voltage source;
a buffer circuit;
a first selection circuit having a first input coupled to an output of the buffer circuit, a second input coupled to a charge sharing line, and an output configured to be coupled to a LCD data line, the first selection circuit further configured to selectively couple the buffer circuit and the charge sharing line to the LCD data line responsive to a charge sharing control signal; and
a second selection circuit having a first input coupled to the video voltage source, a second input coupled to an alternative voltage source, and an output coupled to an input of the buffer circuit, the second selection circuit further configured to selectively couple the video voltage source and the alternative voltage source to the buffer circuit input responsive to the charge sharing control signal.

11. The source driver circuit of claim 10, wherein the alternative voltage source comprises the charge sharing line.

12. The source driver circuit of claim 10, wherein the alternative voltage source comprises a reference voltage source.

13. The source driver of claim 10, wherein the video voltage source comprises a digital-to-analog converter (DAC).

14. A LCD apparatus comprising the source driver circuit of claim 10 and a LCD panel coupled thereto.

15. A method of operating a LCD source driver that includes a selection circuit having an output coupled to a LCD data line, a first input configured to be coupled to a voltage source, and a second input coupled to a charge sharing line, the method comprising:
selectively coupling the first and second inputs of the selection circuit to the LCD data line responsive to a charge sharing control signal; and
controlling voltage at the first input of the selection circuit responsive to the charge sharing control signal.

16. The method of claim 15, wherein controlling voltage at the first input of the selection circuit comprises selectively coupling a video voltage source and an alternative voltage source to the first input of the selection circuit responsive to the charge sharing control signal.

17. The method of claim 16, wherein the alternative voltage source comprises the charge sharing line.

18. The method of claim 16, wherein the alternative voltage source comprises a reference voltage source.

19. The method of claim 2, wherein selectively coupling a video voltage source and an alternative voltage source to the first input of the selection circuit responsive to the charge sharing control signal comprises selectively applying the video voltage source and the alternative voltage source to an input of a buffer circuit having an output coupled to the first input of the selection circuit.
